(19) United States
(12) Patent Application Publication
(10) Pub. No.: US 2002/0174081 A1
(43) Pub. Date: Nov. 21, 2002

(54) System and method for valuation of companies

(76) Inventors: Louis Charbonneau, Montreal (CA); Edward A. Raha, Fairfield, CT (US); Xianguo Wang, Fairfield, CT (US)

Correspondence Address: PENNIE AND EDMONDS, 1155 AVENUE OF THE AMERICAS, NEW YORK, NY, 100362711

(21) Appl. No.: 09/846,891

(22) Filed: May 1, 2001

(51) Int. Cl. G06F 15/18

(52) U.S. Cl. 706/15; 705/35

(57) ABSTRACT

The present invention determines the fair market value of a company based upon the company's fundamental financial data. The invention does not rely upon time series valuation data for the company being evaluated and can be applied to privately-held companies as well as publicly-traded companies. In a preferred embodiment of the present invention, a neural network is trained to learn nonlinear interpolation relations mapping a company's fundamental financial data to a fair value. Preferably, information regarding endpoints for a range of values that represent valuations of the company within a predetermined confidence level is also provided

### FIELD OF THE INVENTION

This invention relates to a system and method for providing valuations of private and publicly-traded companies.

### BACKGROUND OF THE INVENTION

The valuation of companies plays a central role in various aspects of corporate finance. For example, a fair value must be established for companies undergoing (a) changes in corporate control, such as hostile takeovers and management buyouts, (b) financing, and (c) initial public offerings. Fair values may also be useful for families undergoing estate transitions to aid them in evaluating the fair value of a company for estate tax purposes. In addition, portfolio managers may wish to value companies with the aim of trading stocks of companies that are either under or over-valued by the market.

One widely-used method for valuing companies involves calculating the present value of the predicted future income stream of the company. However, projecting the future income stream of a company is an inexact process that requires analysts to project future financial information for the company including future earnings per share, dividends, and sales, supplemented by such difficult to quantify factors as a company's intra-company dynamics, the company's interaction with its competitors, new legislation that may impact the company, and the effect of new product lines on the company. Furthermore, forecasting discount rates is also an inexact process based upon unpredictable economic variables. In addition, analysts often harbor personal financial interests that conflict with the task of estimating stock values. Due to the flaws associated with this valuation method, different analysts often disagree on company values.

Neural networks may be better suited for valuing companies than analysts, if only for the fact that they are not influenced by financial interests. Techniques for valuing companies using neural networks have been described in a number of patents including U.S. Pat. No. 5,761,442 to Barr et al., U.S. Pat. No. 5,761,386 to Lawrence et al., U.S. Pat. No. 5,461,699 to Arbabi et al., U.S. Pat. No. 5,444,819 to Negishi, and U.S. Pat. No. 5,255,347 to Matsuba et al. Generally, the systems described in these patents attempt to forecast the future value of a company rather than determining the current value of the company. This increases the inaccuracy of the valuations, since many factors used by these systems can change drastically over time. In addition, it is recognized that, while neural networks are good at performing interpolations, they are poor forecasting devices (Kohonen, 1992, Bishop, 1995, Skapura, 1996).

In addition, many of the known techniques determine company valuations by deriving market trends from time series market valuation data, such as stock prices, and then using the market trends to value companies. However, trends in time series data often do not reflect the true value of a company. This is seen most recently in the meltdown of the technology sector, where long upward market trends for valuations of many technology companies led to unrealistically high market valuations. In addition, the recent work of Li and Coop (2000) and Hunt-McCool et al.(1996) on Bayesian stochastic frontiers show that factors such as the interest rate, the reputation of the underwriter of particular stocks, and the “hotness” of the stocks can influence market trends which can lead to false valuations.

Furthermore, the time series market data used by these neural networks are not available for companies that are not publicly traded, so that these companies can not be valued by these neural networks.

Therefore, there is a need for a system and process for valuing companies that determines the current value of the company rather than forecasting the future value of the company, that interpolates fundamental financial data of a company rather than extrapolates market trends from time series market data, that can be used to value privately-held companies as well as publicly-traded companies, and that is free from the influence of financial interests of analysts.

### SUMMARY OF THE INVENTION

It is therefore an object of the present invention to provide a system and method for valuing companies by interpolating fundamental financial data of a company without using time series market valuation data.

It is another object of the invention to provide a system and method for determining the current value of a company rather than forecasting their future values.

It is yet another object of the invention to provide a system and method for valuing companies that can value privately-held companies as well as publicly-traded companies.

These and other objects are realized by the system and method of the present invention. Briefly, the present invention determines the fair market value of a company based upon the company's fundamental financial data. The invention does not rely upon time series valuation data for the company being evaluated and can be applied to privately-held companies as well as publicly-traded companies. In a preferred embodiment of the present invention, a neural network is trained to learn nonlinear interpolation relations mapping a company's fundamental financial data to a fair value.

The process of training the neural network, according to a preferred embodiment of the present invention, begins with constructing input and model output matrices for the training set, where each column of the input matrix contains values derived from fundamental financial information for a specific company and the corresponding column of the output matrix contains an estimate of the fair market of the company. Preferably, the output matrix contains three valuations for each company—the median estimated value and endpoints of a range of values for a particular confidence level (e.g. a 90% confidence level that the fair market value will fall between the two endpoints).

Since the fair market values of the companies in the training set are not known, a proxy for them must be used. In a preferred embodiment of the present invention, the proxy values are derived from time series market valuation data, using a novel application of a Hodrick-Prescott filter. The time-series data is used only for deriving model output values for use in training the neural network and is not used later by the neural network when determining the fair market value of a specific company. The data used in deriving the input and output matrices is available from commercial data providers such as Reuters, S&P Compustat, AAII Stockpac, or Value Line. The input matrix contains elements derived from fundamental financial data for companies as well as elements containing information regarding industry groups. The matrix is preprocessed by an input processing module so that it is in a format acceptable to the neural network. Likewise, the model output matrix is preprocessed by model output processing module.

The neural network preferably contains four fully connected layers that are preferably trained sequentially using a back propagation algorithm or any fast weight-modification algorithm such as Levenberg-Marquardt algorithm. During each training period, or epoch, the error of the neural network is calculated by comparing the output from the neural network against the model output matrix. When the error decreases to a preset value or when the error stops decreasing with each epoch, the training process ends, nonlinear interpolation relations are saved, and the neural network is ready to operate in a production mode where private or publicly-traded companies are valued.

During the production mode, an input matrix is constructed using fundamental financial information for the company to be valued. The model output matrix is not required since that matrix is only used for training the neural network. The input matrix is then processed by the input processing module and then entered into the trained neural network, which in turn outputs a raw output matrix. The raw output matrix from the neural network is post-processed by the post-processing module to extract the estimated fair market value and the two boundary values, defining, e.g. a 90% confidence interval.

### BRIEF DESCRIPTION OF THE DRAWINGS

FIG. 1 is a block diagram illustrating a valuation system in accordance with a preferred embodiment of the present invention;

FIG. 2 is a block diagram illustrating the operation of a preferred embodiment of the present invention;

FIG. 3 illustrates the X and Y matrices used in a preferred embodiment of the present invention;

FIG. 4 is a flowchart illustrating the process of constructing the input matrix;

FIG. 5 is a flowchart illustrating the process of constructing the model output matrix; and

FIG. 6 illustrates the training process of the neural network.

### DETAILED DESCRIPTION OF THE PREFERRED EMBODIMENTS

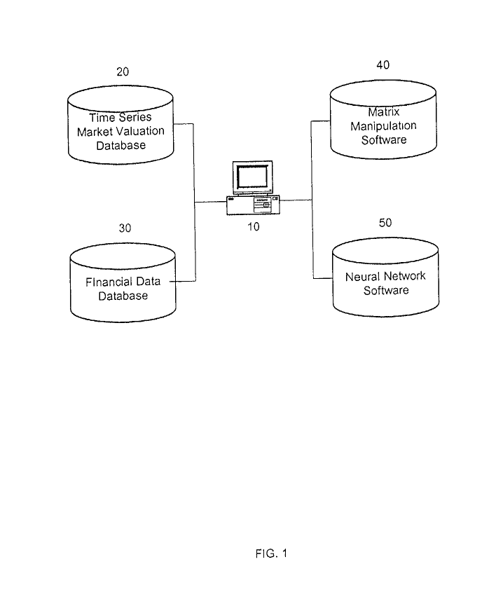

FIG. 1 is a block diagram of a system for valuing a company in accordance with the present invention. The system includes a computer 10 capable of accessing and executing neural network software 50 and matrix manipulation software 40 and capable of accessing a time series market valuation database 20 and a financial data database 30. In an alternative embodiment, more than one computer may be used in the system.

Time series market valuation database 20 contains time series market valuation data for various companies, including those companies in the training set for the neural network. Market valuation data for a company is data regarding how a market, such as a stock market, values a company and typically includes share price and the number of outstanding shares. Financial database 30 contains fundamental financial data for companies. Fundamental financial data for a company refers to data that is typically kept on the accounting books of a company or can be directly derived from data in the accounting books. Examples of fundamental financial data are earnings, sales, operating expenses and other expenses, income, cash, receivables, assets, depreciation, liabilities and debt. The fundamental financial data is used for training the neural network as well as for valuing companies. Matrix manipulation software 40 constructs and processes matrices used as inputs and outputs to the neural network. The matrices are derived from data in time series market valuation database 20 and financial data database 30. The preferred matrix manipulation software 40 is Mathematica (www.wolfram.com). Alternatively, other matrix manipulation software such as Matlab (www.mathworks.com), GAUSS (www.aptech.com), or SAS-IML (www.sas.com) may be used. Neural network software 50 contains the software tools for implementing a neural network and training it. Such neural network software is commercially available and well known to those skilled in the art.

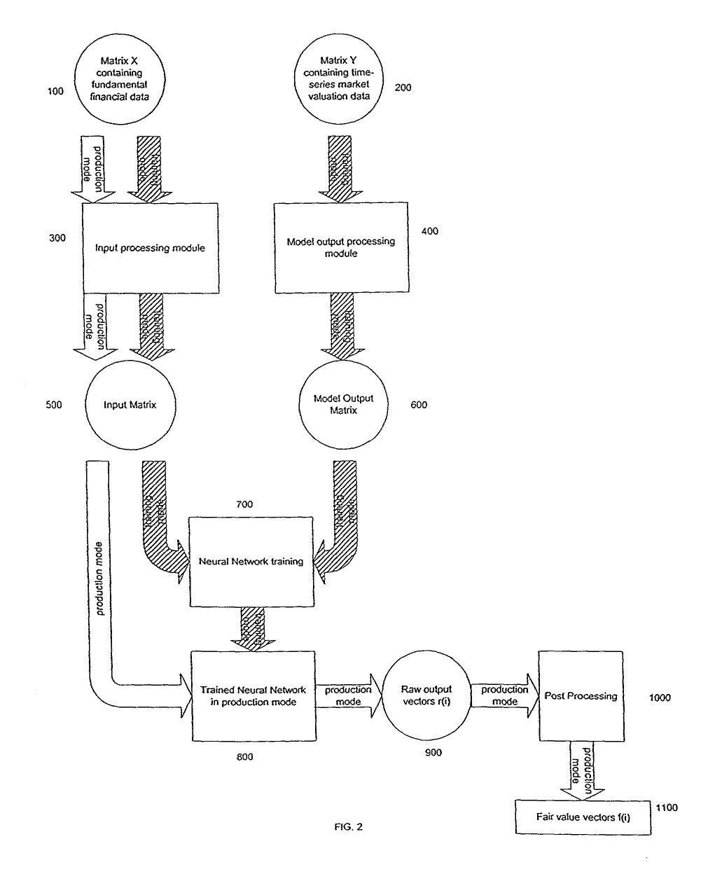

FIG. 2 is a block diagram illustrating the process of valuing a company according to a preferred embodiment of the present invention. In FIG. 2, circles represent matrices and rectangles represent processes performed on the matrices. The valuation process is carried out in two modes, the training mode and the production mode, denoted respectively in FIG. 2 by shaded arrows labeled “training mode” and solid arrows labeled “production mode.” In the training mode, the neural network 800 is trained to learn nonlinear interpolation relations for valuing companies in a training set. In the production mode, neural network 800 produces valuations of companies outside the training set using the nonlinear interpolation relations learned in the training mode. Neural network 800 can also value companies included within the training set.

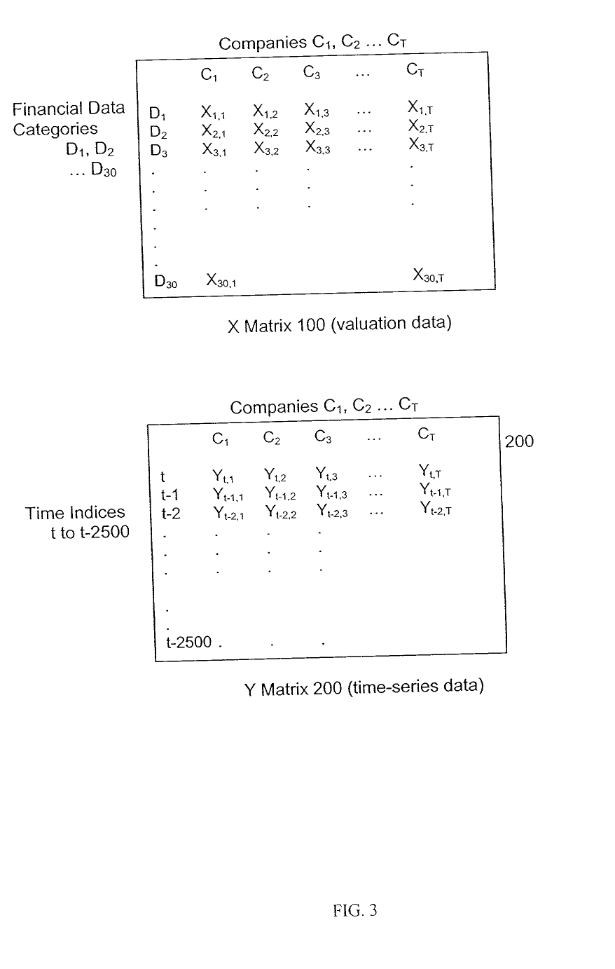

The valuation process begins in the training mode with the construction of X and Y matrices 100, 200, shown in FIG. 3, using fundamental financial data and time series market valuation data, respectively. Such data is available from commercial data providers such as Reuters, S&P Compustat, AAII Stockpac and Value Line. As shown in FIG. 3, each column of X matrix 100 corresponds to a particular company (C₁ to C_{T}), and each row of X matrix 100 corresponds to a category of fundamental financial data. In one preferred embodiment, the following 30 categories of fundamental financial data, designated D1 to D30, are used:

D1: log EBITDA (earnings before interest, taxes, deductions and amortization).

D2: 1 quarter momentum of the log EBITDA, calculated as the current log EBITDA minus the log EBITDA from the last quarter.

D3: 2 quarter momentum of the log EBITDA, calculated as the current log EBITDA minus the log EBITDA from the quarter before the last.

D4: 3 quarter momentum of the log EBITDA, calculated as the current log EBITDA minus the log EBITDA from the 3rd past quarter.

D5: log sales

D6: 1 quarter momentum of the log sales, calculated as the current log sales minus the log sales from the last quarter.

D7: 2 quarter momentum of the log sales, calculated as the current log sales minus the log sales from the quarter before the last.

D8: 3 quarter momentum of the log sales, calculated as the current log sales minus the log sales from the 3rd past quarter.

D9: log operating expenses.

D10: 1 quarter momentum of the log operating expenses, calculated as the current log operating expenses minus the log operating expenses from the last quarter.

D11: 2 quarter momentum of the log operating expenses, calculated as the current log operating expenses minus the log operating expenses from the quarter before the last.

D12: 3 quarter momentum of the log operating expenses, calculated as the current log operating expenses minus the log operating expenses from the 3rd past quarter.

D13: log gross debt outstanding

D14: 1 quarter momentum of the log gross debt outstanding, calculated as the current log gross debt outstanding minus the log gross debt outstanding from the last quarter.

D15: 2 quarter momentum of the log gross debt outstanding, calculated as the current log gross debt outstanding minus the log gross debt outstanding from the quarter before the last.

D16: 3 quarter momentum of the log gross debt outstanding, calculated as the current log gross debt outstanding minus the log gross debt outstanding from the 3rd past quarter.

D17: log SG&A expenses (selling, general and administrative expenses).

D18: log interest expenses

D19: log pretax income

D20: log net income

D21: log cash

D22: log receivables

D23: log current assets

D24: log depreciation

D25: log total assets

D26: log current liabilities

D27: log debt load

D28: log short-term debt

D29: log long-term debt

D30: log book value.

In the descriptions of the categories of financial data above, log is the natural logarithm, often denoted by ln.

The selection of the above categories of fundamental financial data is guided by academic literature on valuation in modern finance. For example, Myers and Majluf (1984) recommends that a company's level of debt should be used in the assessment of its relative value since companies with optimal debt-equity ratio for its industry likely have a better value than companies with sub-optimal ratios. Krinsky and Rotenberg (1989) and Ritter (1984) show that there is a positive relationship between a firm's historical accounting information and its relative value. In addition, according to Teoh et al. (1998a, b), a company's cash flow plays an important role in its valuation. Kim and Ritter (1999) recommends using earnings in the prior fiscal year to measure a firm's ability to generate income for its shareholders.

Alternative or additional categories of fundamental financial data may be used instead of the above categories, and the present invention is not limited to the specific categories chosen.

The fundamental financial data is largely contemporaneous in time and forms a snap shot of a company's financial status. A few categories of fundamental financial data are derived from data points taken from the three most recent quarters, one data point for each quarter, and supply growth rate information. These categories differ from the time series market valuation data in the prior art which typically includes hundreds of data points that are used to derive a market trend, which is then used for extrapolating a forecast of future company valuation. The categories used in the present invention are instead interpolated by the neural network to arrive at a current value, not a forecasted or extrapolated value.

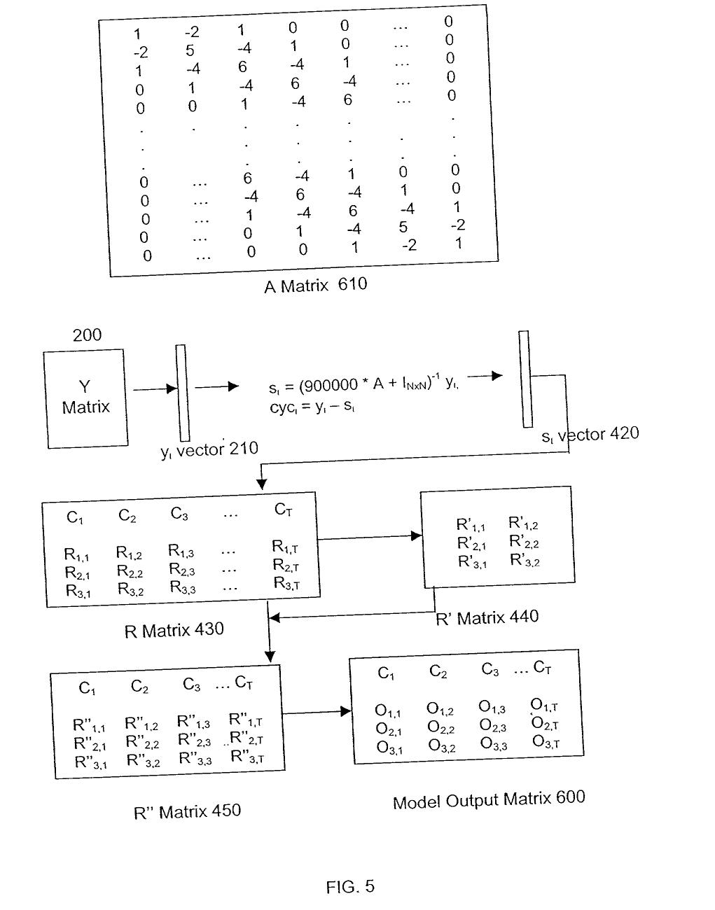

If data for a company is unavailable for any of the categories, a remedial data preparation method is preferably used, such as replacing the missing values by the median values of a selected group of stocks of the same industry. If remedial data preparation is used, confidence interval boundaries described below in connection with FIG. 5 cannot be accurately computed.

Y matrix 200 in FIG. 3 contains time series market valuation for each company C₁ to C_{T}. The same columns in the X and Y matrices 100, 200 preferably correspond to the same company. Each row of Y matrix 200 preferably corresponds to a given time so that elements in any row of matrix Y are contemporaneous. Each adjacent row preferably differs by one day, and elements residing near the top rows are preferably more recent in time than those in the bottom rows. These details may of course be varied and the invention encompasses all such variations. In a preferred embodiment, each element of matrix Y 200 is calculated by taking the natural logarithm of the market value of the corresponding company on a particular day, as given by the following equation:

Y(t,k)=ln(closing market price of stock of company k at time t*number of common stock shares outstanding at time t),

where ln denotes the natural logarithm.

The number of common shares may have to be adjusted to represent fully diluted shares. In the case of a company with preferred stock outstanding, convertible debt outstanding, or a significant amount of warrants (other option-like instruments that may be converted to common shares), common shares outstanding has to be suitably increased.

Referring back to FIG. 2, after X and Y matrices 100, 200 are constructed, the valuation process according to the invention processes the matrices so that they can be used to train the neural network. Input processing module 300 processes X matrix 100 to produce input matrix 500 which is, in turn, used as the input to the neural network. Model output processing module 400 processes matrix Y 200 to produce a model output matrix 600 that is used to train the neural network and determine the accuracy of its output.

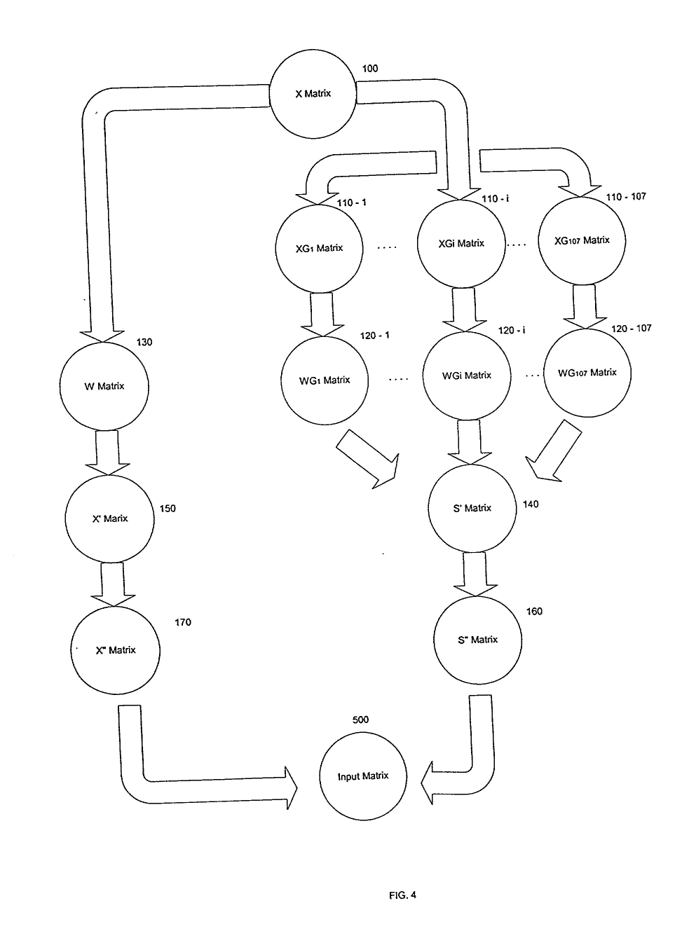

The steps performed by input processing module 300 is depicted in further detail in FIG. 4. First, X matrix 100 is broken into smaller XGᵢ matrices 100-1 through 110-107 on the basis of industry groups, where the subscript i indexes a particular industry group. Specifically, columns of X matrix 100 corresponding to companies belonging to the same industry group are combined to form an XGᵢ matrix 110-i. In this manner, an XGᵢ, matrix 110-i is constructed for each industry group.

In one embodiment, the following 107 industry groups specified by the S&P 500 Industry are used:

Basic Materials

1. Agricultural products

2. Aluminum

3. Chemicals

4. Chemicals (diversified)

5. Chemicals (specialty)

6. Construction (cement & aggregates)

7. Containers & packaging (paper)

8. Gold & precious metals mining

9. Iron & Steel

10. Metals mining

11. Paper & Forest Products

Capital Goods

12. Aerospace/defense

13. Containers (metal & glass)

14. Electrical equipment

15. Engineering & construction

16. Machinery (diversified)

17. Manufacturing (diversified)

18. Manufacturing (specialized)

19. Office equipment & supplies

20. Trucks & parts

21. Waste management

Communication Services

22. Telecommunications (cellular & wireless)

23. Telecommunications (long distance)

24. Telephones

Consumer Cyclicals

25. Auto parts & equipment

26. Automobiles

27. Building materials

28. Consumer jewelry, novelties & gifts)

29. Footwear

30. Gaming, lottery and parimutuel

31. Hardware & tools

32. Homebuilding

33. Household furnishing & appliances

34. Leisure time products

35. Lodging & hotels

36. Publishing

37. Publishing—newspapers

38. Retail (building supplies)

39. Retail (computer & electronics)

40. Retail (department stores)

41. Retail (discount stores)

42. Retail (general merchandise)

43. Retail (specialty)

44. Retail (specialty apparel)

45. Services (advertising & marketing)

46. Services (commercial & consumer)

47. Textiles (apparel)

48. Textiles (home furnishings)

Consumer Staples

49. Beverages (alcoholic)

50. Beverages (non-alcoholic)

51. Broadcasting (TV, radio & cable)

52. Distributors (food & health)

53. Entertainment

54. Foods

55. Household products (non durables)

56. Housewares

57. Personal care

58. Restaurants

59. Retail (drug stores)

60. Retail (food chains)

61. Specialty printing

62. Tobacco

Energy

63. Oil & gas (drilling & equipment)

64. Oil & gas (exploration & production)

65. Oil & gas (refining & marketing)

66. Oil (domestic integrated)

67. Oil (international integrated)

Financial

68. Banks (major regional)

69. Banks (money center)

70. Consumer finance

71. Financial (diversified)

72. Insurance brokers

73. Insurance (life & health)

74. Insurance (multi-line)

75. Insurance (property-casualty)

76. Investment banking & brokerage

77. Investment management

78. Savings & loans

Health Care

79. Biotechnology

80. Health care (diversified)

81. Health care (drugs—generic & other)

82. Health care (drugs—major pharmaceuticals)

83. Health care (hospital management)

84. Health care (long-term care)

85. Health care (managed care)

86. Health care (medical products & supplies)

87. Health care (specialized services)

Technology

88. Communications equipment

89. Computers (hardware)

90. Computers (networking)

91. Computers (peripherals)

92. Computers (software & services)

93. Electronics (component distributors)

94. Electronics (defense)

95. Electronics (instrumentation)

96. Electronics (semiconductors)

97. Equipment (semiconductor)

98. Photography/imaging

99. Services (computer systems)

100. Services (data processing)

Transportation

101. Air freight

102. Airlines

103. Railroads

104. Truckers

Utilities

105. Electric companies

106. Natural gas

107. Power producers (independent).

Alternatively, other classification schemes may be used, such as, but not limited to, the Standard Industry Classification. In addition, automatic classification algorithms such as learning vector quantization (LVQ, Kohonen, 1992) or self-organizing maps may classify companies based on similarities in their financial data. Classifying companies according to industry groups allows the valuation process to capture and account for idiosyncracies of each industry group. For instance, certain accounting variables such as debt level have higher values in certain industries and lower values in others (Downes and Heinkel, 1982).

Again, in the presently described embodiment, the 107 industry groups from the S&P 500 Industry Survey are used and X matrix 100 is accordingly broken into 107 smaller matrices XG₁ 110-1 through XG₁₀₇ 110-107 as shown in FIG. 4.

Next, matrices WG₁ 120-1 through WG₁₀₇ 120-107 are constructed for each industry group using statistical information derived from matrices XG₁ 110-1 through XG₁₀₇ 110-107, respectively. The WGᵢ matrices 120-i each have 2 columns and 30 rows (one row for each financial data category). For each row, the first column is set to the median value of the data in the same row in the corresponding XGᵢ matrix 110-i and the second column is set to the standard deviation of the data in the same row in the corresponding XG₁ matrix 110-i.

A W matrix 130 is constructed in the same manner using the entire X matrix 100, so that medians and standard deviations are calculated for each financial data category across all industry groups.

X′ matrix 150 is then constructed using the following equation:

X′(i,j)=(X(i,j)−W(i,1))/W(i,2),

where i is a row number, j is a column number, W(i, 1) is the median of the i^{th} row of X matrix 100, and W(i, 2) is the standard deviation of the i^{th} row of X matrix 100.

Each element of X′ matrix 150 is thus the difference between an element in X matrix 100 and median value for its row, divided by the standard deviation for its row.

Elements in X′ matrix 150 are then scaled to yield X″ matrix 170. Specifically, in the preferred embodiment, each element of X′ matrix 150 is multiplied by 0.9 and divided by the absolute value of the element in the corresponding row of X′ matrix 150 with the largest absolute value. This calculation is given by the following equation:

X″(i,j)=0.9*X′(i,j)/max (|X′(i,:)|);

where X′ (i,:) refers to all values in row i of matrix X′.

The scaling yields values between −1 and 1, which is the required range for input into a neural network.

S′ matrix 140 is a 5×T matrix whose columns correspond to companies 1 to T as in X and Y matrices 100, 200. The first row of S′ matrix 140 contains elements that are either 0.5 or −0.5, where an element is 0.5 if the company corresponding to that column uses the LIFO accounting method and −0.5 if FIFO accounting method is used.

Rows 2 to 5 of S′ matrix 140 contain weighted industry group data for four categories of fundamental financial data, specifically D1, D5, D9, and D13. These categories are chosen because they are recognized by those skilled in the art to be the most pertinent to valuing a company. Elements in row 2 of the S′ Matrix are calculated using the following equation:

S′(2,j)=(WG_{g(j)}(1,1)−W(1,1))/standard deviation of (WG₁(1,1), WG₂(1,1), . . . , WG₁₀₇(1,1)),

where G(j) is a group indicator function which returns the group number of the industry group of the company corresponding to column j.

Thus, each element in the second row of S′ matrix 140 represents the difference between the median of EBITA data (i.e., D1) for industry groups G and the median of the EBITA data across all industry groups divided by standard deviation taken over all industry group medians for EBITA data. The other rows of the matrix S′ are similarly calculated using fundamental financial data from categories 5, 9 and 13:

S′(3,j)=(WG_{G(j)}(5,1)−W(5,1))/standard deviation of (W₁(5,1), W₂(5,1), . . . , W₁₀₇(5,1))

S′(4,j)=(WG_{G(j)}(9,1)−W(9,1))/standard deviation of (W₁(9,1), W₂(9,1), . . . , W₁₀₇(9,1))

S′(5,j)=(WG_{G(j)}(13,1)−W(13,1))/standard deviation of (W₁(13,1), W₂(13,1), . . . , W₁₀₇(13,1))

Next, elements of the S′ Matrix are scaled using the following equation to yield S″ matrix 160:

S″(i,j)=0.9*S′(i,j)/max (|S′(:,j)|)).

Input matrix 500 is constructed simply by appending S″ matrix 160 to the bottom of X″ 170 matrix. In the preferred embodiment, when new quarterly fundamental financial data is made available, the training process should be repeated to reflect the new information.

Referring back to FIG. 2, the process by which model output processing module 400 generates model output matrix 600 will now be described. In a preferred embodiment, model output matrix 600 has T columns, one for each of the T companies in the training set, and 3 rows. The first row contains the estimated median value for each company, and the second and third rows contain the endpoints of a range of values within a specified confidence level; for example, a 90% confidence level that the fair value for the company falls within the range. The elements of model output matrix 600 are derived from time series market valuation data for companies 1 to T. They represent the desired output of the neural network for the purposes of training and are compared against the actual outputs of the neural network to determine the accuracy of the neural network. The model output matrix 600 is used only in the training mode and is not for valuing companies in production mode.

Model output processing module 400 produces model output matrix 600 by filtering the time series market valuation data to filter out market noise. This serves as a proxy for a valuation based on company fundamentals, which is the desired output of the neural network. The preferred low-pass smoothing filter is a Hodrick-Prescott (HP) filter used in macroeconomic models (Hodrick and Prescott, 1980). The HP filtered series is the function s(t) that satisfies the following minimization equation:

$$Min {\sum }_{t} ( {( y ( t ) - s ( t ) )}^{2} + {S ( ( s ( t + 1 ) - s ( t ) ) - ( s ( t ) - s ( t - 1 ) ) )}^{2} ) ,$$

where y(t) is the original unfiltered series, s(t) is the filtered series, and S is a priority weight parameter.

The first part of the minimization equation, (y(t)−s(t))², attempts to minimize the distance between the original series y(t) and the filtered series s(t) (i.e., it attempts to make the filtered series close to the original series). The second part of the equation, S((s(t+1)−s(t))−(s(t)−s(t−1)))², attempts to minimize the second derivative, or the curvature, of the filtered series s(t) (i.e., it attempts to minimize the rate of change of the filtered series data). The S parameter is used to emphasize or attenuate the importance of minimizing the curvature of the filtered series s(t). Higher values of S assign greater importance to minimizing the curvature of the filtered series s(t) and lower values assign lesser importance to it. In an extreme case, if an infinite value is assigned to the S parameter, minimizing the curvature of s(t) becomes the paramount importance, and the above minimization process becomes an ordinary regression process, yielding a straight line for the filtered series s(t).

Preferably, the S parameter for a company is a relatively high value in the range of 100,000 to 1,500,000. A suitable value for the S parameter may be determined graphically by comparing the filtered series s(t) to the actual time series market valuation data. A good S parameter is one that produces a filtered series s(t) that achieves a good fit with the actual time series data points with as few inflection points as possible.

FIG. 5 illustrates a process for generating the HP filter smoothed series s(t). Y matrix 200 is first broken up into individual column vectors yᵢ210 so that valuation of each company in the test set is treated individually. Next, a square symmetric band A matrix 410 is constructed as follows:

A(i,j)=0 if |i−j|=3, (band)

A(i,j)=A(j,i), (symmetry)

A(1,1)=A(1,3)=A(2,4)=A(k,k+2)=A(D,D)=1,

A(1,2)=A(D,D−1)=−2,

A(2,2)=A(D−1,D−1)=5,

A(k,k)=6 if 3=k=D−2, where D is the dimension of the square matrix, and k is any integer between 1 and D.

Column vectors sᵢ 420, equivalent to s(t) of the HP minimization equation, are then calculated for each time series yᵢ vector 210 using the following matrix operation:

sᵢ=(900000*A+I)⁻¹*yᵢ,

where I denotes the identity matrix and the superscript −1 indicates matrix inversion.

Next, cyclical residuals of company i, cycᵢ, are calculated, expressed in vector form as:

Cycᵢ=yᵢ−sᵢ

Cyclical residuals cycᵢ represent noise in original time series y₁.

The first 100 and the last 100 observations of vector cycᵢ are eliminated since the HP filter does not work well near end points of the time series. Next, the 5th and 95th percentiles of the truncated cyclical distribution for each company, ai and bi respectively, is computed. R matrix 430 is then constructed using sᵢ, aᵢ, and bᵢ according to the following equations:

R(1,i)=sᵢ(t−40,1)+bᵢ

R(2,i)=sᵢ(t−40,1)

R(3,i)=sᵢ(t−40,1)+aᵢ

Row one of R matrix 430 contains the values of the smoothed series sᵢ at 40 periods (preferably each period being one day) prior to the most recent time that market valuation information is available for company i plus the 95th percentile of the distribution of cyclical residuals. Row two of R matrix 430 contains the values of the smoothed series sᵢ at 40 periods prior to the most recent time that market valuation information is available for company i. Row three of R matrix 430 contains the values of the smoothed series sᵢ at 40 periods prior to the most recent time that market valuation information is available for company i plus the 5th percentile of the distribution of cyclical residuals. The value aᵢ is typically a negative number and the value b₁ is typically a positive number so that element R(2,i) is bounded by elements R(1,i) and R(3,i). This process produces a 90% confidence level interval of the fair market capitalization value. In alternative embodiments, other confidence level intervals may be used.

Elements of R matrix 430 are then normalize and scaled to yield R′ matrix 440. Medians of each row of the R matrix is calculated and stored in the first column of the R′ matrix. Standard deviations for each row of the R matrix is calculated and stored in the second column of the R′ matrix:

R′(1,1)=median (R(1,:)), R′(1,2)=standard deviation (R(1,:))

R′(2,1)=median (R(2,:)), R′(2,2)=standard deviation (R(2,:))

R′(3,1)=median (R(3,:)), R′(3,2)=standard deviation (R(3,:))

Next, elements of the R′ matrix 440 are standardized as follows, resulting in R″ matrix 450:

R″(i,j)=(R(i,j)−R′(i,1))/R′(i,2)

R″ matrix 450 is then scaled using the equation below to produce model output matrix 600:

O(i,j)=0.9*R″(i,j)/max (|R″(i,:)|)

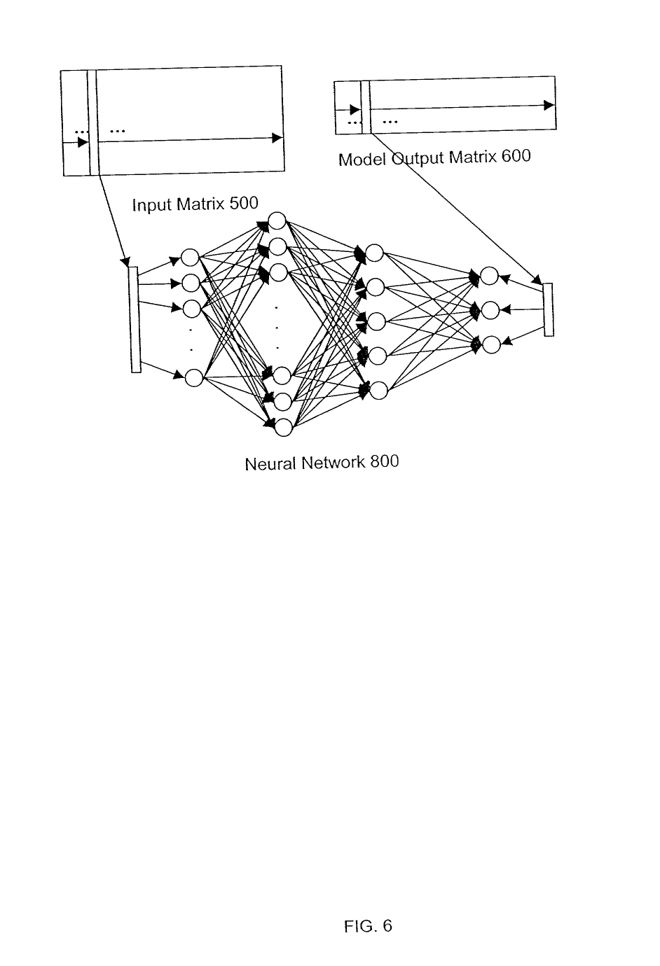

After the input and model output matrices 500, 600 for the training set have been created, the neural network can now be trained, as shown (block 700 of FIG. 2). The training process is illustrated in further detail in FIG. 6. Neural network 800 preferably has 4 fully interconnected layers using hyperbolic tangent squashing functions, though any suitable squashing function for nonlinear interpolation can be used. In the preferred embodiment, there are 35 input nodes, 40 nodes in the first hidden layer, 7 nodes in the second hidden layer, and 3 output nodes. Of course, those skilled in the art will appreciate that a different number of input nodes, hidden layers, hidden nodes and output nodes may be used. Columns of input and model output matrices 500, 600 are presented sequentially to the input and the output layers, respectively. Each pass through all the columns of the input and output matrices 500, 600 is called an epoch. Standard backpropagation algorithms (described for instance in Bishop, 1995, Skapura, 1996 and Reed, 1999) or any weight-modification algorithm such as the Levenberg-Marquardt algorithm, may be used to change the weights of the nodes for each training exemplar to improve nonlinear interpolation.

For each epoch, an error is calculated from the sum of the squared differences between the actual output and model output 600 multiplied by the slope of the squashing functions, if back-propagation is used. The error should trend lower with increasing epochs. Training should end when the error either reaches a small predetermined value, or when the error remains the same for consecutive epochs. It is very important to avoid overtraining, otherwise the network will overfit the valuation mapping in the training set and will produce erroneous results. Standard guidelines for training neural networks are found in Skapura, 1996 and Reed, 1999.

Neural network 800 is preferably trained about three months after new quarterly data has become available for companies, as discussed above. Roughly one month is left for the market to adapt to the new fundamentals, and two months to pick a point that can be trusted on the HP trend. In addition, as mentioned above, HP filters do not work well near series end points. Therefore, using the endpoint of the HP filtered series would result in an interpolation of the wrong values, and would adversely affect the results. That is why sᵢ(t−40, 1) is used instead of sᵢ(t, 1).

Referring back to FIG. 2, once the neural network is trained, it may be used to value companies in production mode, denoted by solid arrows labeled “production mode.” In production mode, the valuation process according to the invention constructs the X matrix 100 in the same manner as X matrix 100 was constructed in the training mode, as described above. Y matrix 200 is not needed in the production mode, thus, time series market valuation data for the company to be valued is not used in production mode. This feature of the invention enables valuation of private companies as well as publicly-traded companies. X matrix 100 is processed in input processing module, as illustrated in FIG. 4, resulting in input matrix 500. Input matrix 500 is entered into the trained neural network 800, which in turn produces raw output matrix 900. The raw output vectors r(i) 900 is input to post-processing module 1000, which in turn uses the R′ matrix 440 and R″ matrix 450, constructed in the training phase, as described above, to produce a 3 by 1 fair value vector f(i) 1100 for each column in X matrix 100:

f(i)=exp [R′(i,2)*{max (|R″(i,:)|)*r(i)/0.9}+R′(i,1)],

where exp denotes the exponential function having the Euler number e as basis.

The element f(2) is the estimated fair value of the market capitalization of the stock to be appraised; elements f(1) and f(3) are respectively the estimated higher and lower boundaries of the 90% confidence interval of the fair value. It is of course possible to estimate other confidence intervals (such as 95%) by picking other percentiles to use as inputs in the training phase, or to estimate simultaneously many confidence intervals by adding more output nodes.

While the above provides a full and complete disclosure of a preferred embodiment of this invention, equivalents may be used without departing from the spirit and scope of the invention. Such changes may involve using a different set of valuation variables, doing the interpolation of the fair value mapping via other econometric techniques such as linear or non linear regression, using different neural network architectures such as recurrent networks and different training methods such as robust back propagation, or using various other low-pass filters such as the Baxter-King or Kalman filters, in order to create a suitably smoothed time-series to proxy the fair value. The above description should therefore not be construed as limiting the scope of the invention which is defined by the appended claims.

### REFERENCES

Bishop, C., 1995, “Neural Networks for Pattern Recognition”, Oxford, Clarendon Press.

Downes, H. and R. Heinkel, 1982, “Signaling and the valuation of unseasoned new issues”, Journal of Finance, 37, 1-10.

Hunt-McCool, J., S. C. Koh and B. B. Francis, 1996, “Testing for Deliberate Underpricing in the IPO premarket: A Stochastic Frontier Approach”, Review of Financial Studies, 9, 1251-1269.

Kohonen, T., 1992, “Self-Organizing Maps”, Springer-Verlag, New York.

Krinsky, I. and W. Rotenberg, 1989, “Signaling and the seasoned valuation of new issues revisited”, Journal of Financial and Quantitative Analysis, 24, 257-266.

Kim, M. and J. R. Ritter, 1999, “Valuing IPOs”, Journal of Financial Economics, 53, 409-437.

Li, Kai and G. Coop, 2000, “The Valuation of IPO and SEO Firms”, working paper, Department of Finance, University of British Columbia.

Ritter, J. R., 1984, “The Hot Issue Market of 1980”, Journal of Business, 57, 215-241.

Myers, S. and N. Majluf, 1984, “Corporate Financing and Investment Decisions When Firms Have Information that Investors Do Not Have”, Journal of Financial Economics, 39, 575-592.

Reed, Russel D. and R. J. Marks, 1999, “Neural Smithing”, MIT Press, Cambridge, Mass.

Skapura, David M., 1996, “Building Neural Networks”, ACM Press, New York.

Teoh, S. H, I. Welch and T. J. Wong, 1998a, “Earnings Management and the Long-Run Market Performance of Initial Public Offerings”, Journal of Finance, 53, 1935-1975.

Teoh, S. H, I. Welch and T. J. Wong, 1998b, “Earnings Management and the Underperformance of Seasoned Equity Offerings”, Journal of Financial Economics, 50, 63-99.

What is claimed is:

1. A system comprising one or more computers for determining a fair valuation of a company comprising:
interpolation means capable of receiving as input fundamental financial data for a company and outputting valuation information for the company,
wherein the valuation information output by the interpolation means is substantially derived by the interpolation means from the fundamental financial data and not substantially from time series market valuation data for the company.

2. The system of claim 1 wherein the interpolation means is a neural network.

3. The system of claim 1 wherein the valuation information output by the interpolation means comprises information regarding the current value of the company.

4. The system of claim 1 wherein the fair valuation information comprises a range of values that represent valuations of the company within a predetermined confidence level.

5. The system of claim 2 wherein the neural network is trained with test data relating to a preselected group of companies; and wherein, for each company, the test data comprises fundamental financial data and time series data and wherein input values to the neural network during training are derived from the fundamental financial data and model output values are derived from the time series data.

6. The system of claim 5, wherein the model output values are derived by filtering the time series data using a smoothing filter.

7. The system of claim 5, wherein the model output values are derived by filtering the time series data using a Hodrick-Prescott filter.

8. The system of claim 7 wherein a priority weight parameter in the Hodrick-Prescott filter has a value between 100,000 and 1,500,000.

9. The system of claim 7 wherein a priority weight parameter in the Hodrick-Prescott filter has a value of approximately 900,000.

10. The system of claim 5, wherein the time series data is time series market valuation data.

11. The system of claim 1, wherein the fundamental financial data comprises accounting information.

12. The system of claim 1, wherein the fundamental financial data comprises industry-group-specific information.

13. The system of claim 6 wherein cyclic residuals are derived from the filtered time series data and a range of values that represent valuations of the company within a predetermined confidence level are derived from the cyclic residuals.

14. The system of claim 1 wherein the company being valued is privately held.

15. The system of claim 1 wherein accounting information is available for the company being valued but no market information is available.

16. The system of claim 2 wherein the neural network has a plurality of output nodes comprising median value information and information regarding endpoints for a range of values that represent valuations of the company within a predetermined confidence level.

17. A system comprising one or more computers for determining a fair valuation of a company comprising:
a neural network capable of receiving as input fundamental financial data for a company and outputting valuation information for the company,
wherein the valuation information output by the neural network is substantially derived by the neural network from the fundamental financial data and not substantially from time series market valuation data for the company.

18. A method of determining a fair valuation of a company comprising the steps of:
interpolating fundamental financial data for a company and
outputting valuation information for the company,
wherein the valuation information is substantially derived from the fundamental financial data and not substantially derived from time series market valuation data for the company.

19. The method of claim 18 wherein the step of interpolating is performed by a neural network.
